(19) United States
(12) Patent Application Publication
(10) Pub. No.: US 2003/0122922 A1
(43) Pub. Date: Jul. 3, 2003

(54) Video e-mail system and associated method

(76) Inventors: Kevin D. Saffer, Cincinnati, OH (US); Walter H. Solomon, Lexington, KY (US)

Correspondence Address: TAFT, STETTINIUS & HOLLISTER LLP, SUITE 1800, 425 WALNUT STREET, CINCINNATI, OH, 45202-3957, US

(21) Appl. No.: 10/301,469

(22) Filed: Nov. 21, 2002

Related U.S. Application Data
(60) Provisional application No. 60/333,361, filed on Nov. 26, 2001.

(51) Int. Cl. H04N 7/14; H04N 7/173

(52) U.S. Cl. 348/14.01; 348/14.09; 725/109

(57) ABSTRACT

A computer implemented system and method in which a user can send e-mail messages that include full-motion video and audio (or, alternatively, audio only), along with (if desired) the text messages to an e-mail recipient. The sender merely needs to incorporate camera control software according to certain aspects of the present invention into his/her remote computer/terminal that will coordinate the recording and exchange of such videos using the sender's remote computer and associated video camera. In the exemplary embodiment, the compose screen code includes pre-existing e-mail application code and custom code inserted into pre-existing templates provided by the pre-existing e-mail application code; and further, the camera control application is a discrete application that communicates with pre-existing video camera support application residing on the sender's remote computer. Accordingly, the video email system is configured to operate with pre-existing e-mail application codes and pre-existing video camera support applications without invading the basic system codes of either.

### CROSS-REFERENCE TO RELATED APPLICATIONS

The present application claims the benefit of U.S. Provisional Patent Application Ser. No. 60/333,361, filed Nov. 26, 2001.

### BACKGROUND

The present invention is related to a video messaging service; and, more particularly, a video email system and service that is configured to operate with pre-existing email application codes and pre-existing video camera support applications without invading the basic system codes of either

### SUMMARY

The present inventions are embodied in a computer-network-implemented video messaging service. With the exemplary embodiment of the video messaging service, a user can send e-mail messages that include full-motion video and audio (or, alternatively, audio only), along with (if desired) the text messages to an e-mail recipient. If desired, the sender can even add file attachments, such as digital photos, wordprocessing documents, spreadsheets and/or sound files. The sender merely needs to incorporate camera control software according to certain aspects of the present invention into his/her remote computer/terminal that will coordinate the recording and exchange of such videos using the sender's remote computer and associated video camera (such as any commercially available “web cam”).

Generally, the video e-mail system and service performs the following process: (a) the sender accesses an e-mail server computer over a computer network (such as the Internet); (b) the sender's computer downloads compose screen code (including HTML and JAVA script, for example) from the e-mail server to a browser application (such as Netscape or Microsoft Explorer) or an e-mail application (such as Microsoft Outlook) running on his/her remote computer; (c) the sender composes, if desired, the text e-mail (and attaches any desired attachments) using the compose screen, and also records a video on the sender's computer utilizing camera control software installed on the user's computer that interacts with the compose screen code; (d) the sender activates the “send” icon or button on the compose screen; (e) the camera control software on the sender's computer, in no specific order, compresses the video, uploads the compressed video to a video server (which may be the same server as the e-mail server) over the computer network, and retrieves a video ID from the video server; and (f) the compose screen code on the sender's computer then grabs the video ID and inserts the video ID with a “link” or network address to the video server into the text or code of the composed e-mail message and uploads the composed e-mail message to the e-mail server. The e-mail server then sends this text e-mail message to the intended recipient's e-mail server. When the intended recipient receives the e-mail message, the recipient (a) downloads the e-mail data/code to the browser or the e-mail application (such as Microsoft Outlook) operating on the recipient's remote computer, which displays the message; (b) the recipient activates the link embedded in the message or, alternatively, utilizes his or her web browser to access the web address indicated by the text of the e-mail message; (c) the recipient's browser downloads code from the video server (including HTML and JAVA Script) associated with this link/address to set up a video viewing screen/window on the recipient's remote computer; and (d) the video server streams the video corresponding to the video ID specified in the link/address to the recipient's video viewing screen/window.

Therefore it is an aspect of the present invention to provide a video system the includes: (a) a sender's remote computer operatively coupled to a global computer network, where the sender's remote computer includes a display screen integrated therewith or operatively coupled thereto, at least one i/o device integrated therewith or operatively coupled thereto, a video camera integrated therewith or operatively coupled thereto, a browser application and/or a dedicated email application installed thereon and a camera control application installed thereon; (b) a recipient's remote computer operatively coupled to the global computer network, where the recipient's remote computer operatively coupled to the global computer network, the recipient's remote computer including a display screen integrated therewith or operatively coupled thereto, at least one manual i/o device integrated therewith or operatively coupled thereto and a browser application and/or a dedicated email application installed thereon; (c) an email server operatively coupled to the global computer network, including composing screen code downloadable by the sender's remote computer and compatible with the browser and/or dedicated email application installed on the sender's remote computer, the composing screen code being configured to provide, (i) email composition graphical interface elements enabling the sender to compose an email using the browser and/or the dedicated email application, (ii) video recording graphical interface elements enabling the sender to direct and monitor the recording of media on the sender's computer, and (iii) functional interface elements providing a functional interface between at least the video recording graphical interface elements and the camera control application installed on the sender's remote computer; and (d) a video server operatively coupled to the global computer network adapted to stream media, either directly or indirectly through another server, to the recipient's remote computer; (e) where the camera control software is configured to (i) record media onto the sender's remote computer, (ii) communicate with the video server to upload the recorded media to the video server, (iii) to obtain or define an identity of the uploaded media, and (iv) to interface with the functional interface elements of the composing screen code for inserting a link or an address to the video server along with the identity of the uploaded media into the composed email. Therefore, when the recipient receives the composed email, the recipient need only activate the inserted link (or direct the recipient's browser to the inserted address) so that the recipient's browser or email application will initiate the streaming of the media from the video server.

In the exemplary embodiment, the compose screen code includes pre-existing email application code and custom code inserted into pre-existing templates provided by the preexisting e-mail application code; and further, the camera control application is a discrete application that communicates with pre-existing video camera support application residing on the sender's remote computer. Accordingly, with the exemplary embodiment, the video e-mail system is configured to operate with pre-existing e-mail application codes and pre-existing video camera support applications without invading the basic system codes of either.

### BRIEF DESCRIPTION OF THE DRAWINGS

FIG. 1 is a block diagram representation of an exemplary arrangement of client terminals/computers and associated network severs according to an exemplary embodiment of the present invention;

FIG. 2 illustrates a flow diagram representing an exemplary process for creating a video e-mail according to an aspect of the present invention;

FIG. 3 illustrates a flow diagram representing a specific task of the camera control software involved with sending and compressing a video file to the video server with a unique ID;

FIG. 4 is a flow diagram illustrating an exemplary process for a recipient to view the video created by the sender;

FIG. 5 is an exemplary log-in screen according to an exemplary embodiment of the present invention;

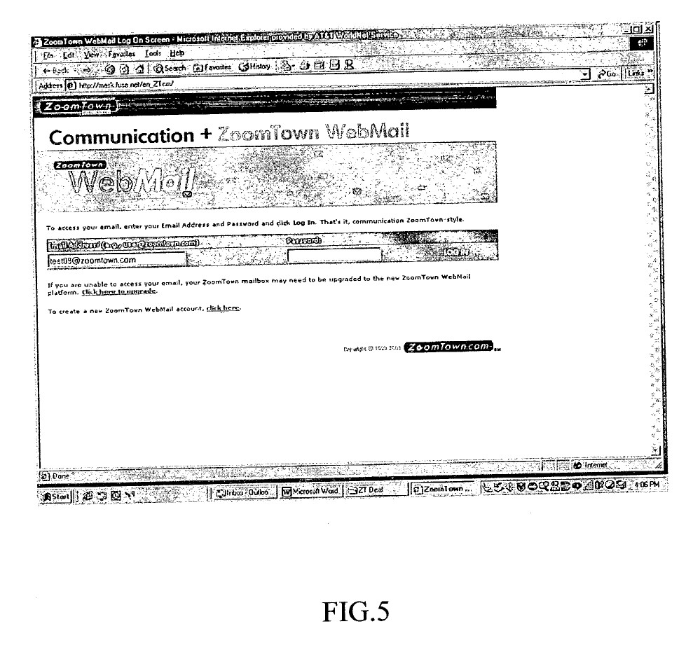

FIG. 6. is an exemplary email composition screen according to an exemplary embodiment of the present invention;

FIG. 7 is the exemplary email composition screen of FIG. 6 approximate the time of sending the video email message;

FIG. 8 is an exemplary embodiment of an email message received according to an exemplary embodiment of the present invention; and

FIG. 9 is an exemplary embodiment of a video viewing screen according to an exemplary embodiment of the present invention.

### DETAILED DESCRIPTION

A description of an exemplary embodiment of the present invention is illustrated by a group of computers/terminals and computer servers connected to one another over a computer network; and, more specifically, a global computer network, such as the Internet.

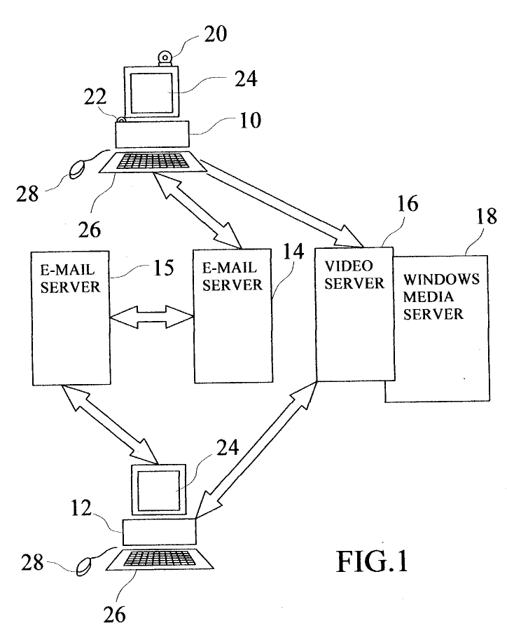

As shown in FIG. 1, the exemplary embodiment of the present invention utilizes a sender's client-computer or terminal 10, a recipient's client-computer or terminal 12, a sender's email server computer 14 (which may be a standard e-mail server), a recipient's e-mail server computer 15, a video server 16 and, if desired, a conventional Windows Media Server 18. It will be understood by those of ordinary skill that the server computers described above may exist collectively on a single server or, in various combinations, on two or more servers. The client-computers 10, 12 are capable of communicating with the server computers 15, 16 & 18 over the Internet.

The sender's computer 10 includes camera control software that has been installed into the sender's computer and, in the exemplary embodiment, the sender's computer (actually, the sender using the sender's computer) is subscribed to the video e-mail service through the video server 16. It will be apparent to those of ordinary skill that down-loading and installation of the camera control software onto the sender's computer may result from the process of the sender subscribing to the video e-mail service. The sender's computer 10 includes a video camera 20 (such as a commercially available “web cam”) installed thereto and operably coupled to the computer 10 and a mike 22 operably coupled to the computer 10. In the exemplary embodiment, the camera control software application is a discrete application that may communicate with pre-existing video camera support application(s) residing on the sender's remote computer. Therefore, the camera control software does not invade the pre-existing system code that resided on the sender's computer 10 prior to installing the camera control software.

The recipient's and sender's computers 12, 10 each have at least one display device, such as a display screen 24, and i/o devices, such as a keyboard 26 and a mouse 28. It is to be understood, however, that the systems and methods described herein can be used with other types of computers, terminals or electronic devices operably coupled to a global computer network, such as laptop computers, Internet appliances, hand-held computers (PDAs and the like) and other electronic communication devices. Furthermore, it is within the scope of the invention to utilize alternate i/o devices available to those of ordinary skill such as, without limitation, touch-screen, voice recognition, touch pad, joy-stick, and the like.

As will be described in greater detail below, the camera control software installed on the senders computer 10 enables: (1) the recording of video and/or audio, (2) the creation or access of a unique ID (and URL) for the video/audio, (3) compression of the video/audio, (4) uploading of the video/audio to the video server 16, and (5) the insertion of the URL or link to the video/audio that has been uploaded to the video server 16 into the e-mail message text or code, which is to be uploaded to the e-mail server 14. The camera control software also conducts session management (i.e., the ability to check to see the status of the a message in the development of a video, etc.) and allows for other functions such as playback of the recorded video prior to sending the video.

The e-mail server 14 is a conventional server running, in the exemplary embodiment, Openwave “Post.Office” software that has been customized, according to the available Openwave customization schemes and templates, to download to the sender's computer browser the necessary code (HTML code and JAVA Script) that allow the compose page to be displayed on the sender's browser or e-mail application and to provide an interface between the compose page and the camera control software. Because the exemplary embodiment utilizes custom code according to pre-existing Openwave templates and schemes, the compose page code is created without invading the basic system code of the pre-existing e-mail application software (OpenWave). The compose page display and operation will be discussed in further detail below.

The video server 16, and the exemplary embodiment, is a LINUX server that serves as a repository for compressed videos created by the sender computers 10; streams video to the recipient's of the e-mail messages; provides an interface to an administrator so that the administer can manage and administrate certain aspects of the video server performance (such as managing video message length, automatic deletion/memory management, etc.); and is optimized to stream the video to the recipient computers 12 in a manner that can most easily viewed by the recipient's computers 12. This is performed by checking the recipient's configuration and/or bandwidth capabilities and streaming the video based upon this detected configuration/bandwidth. The optional Windows Media Server 18 may be used by the video server 16 to stream video to the recipient's computers 12. For example, the use of the Windows Media Server allows streaming a video over lower bandwidth connections (can stream on 26K modem connections using only 18K of bandwidth—able to stream 60 seconds of video uninterrupted).

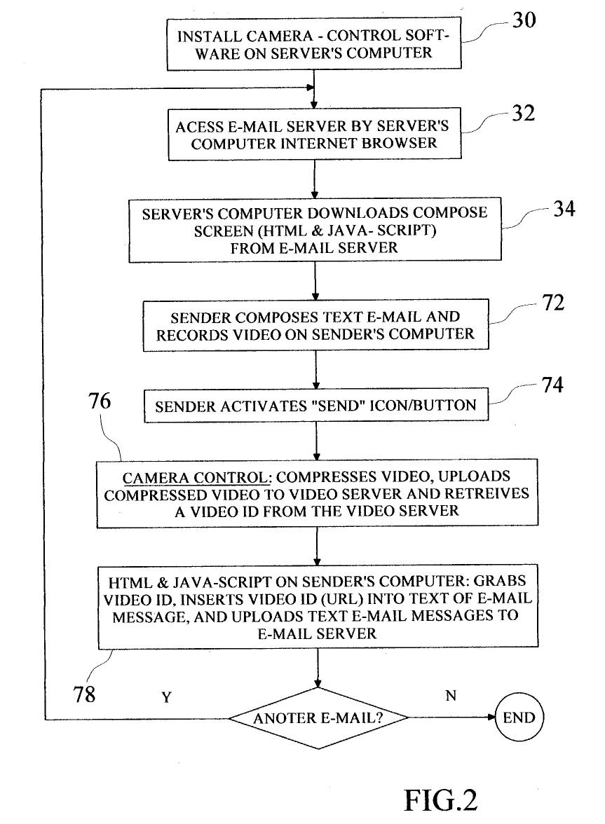

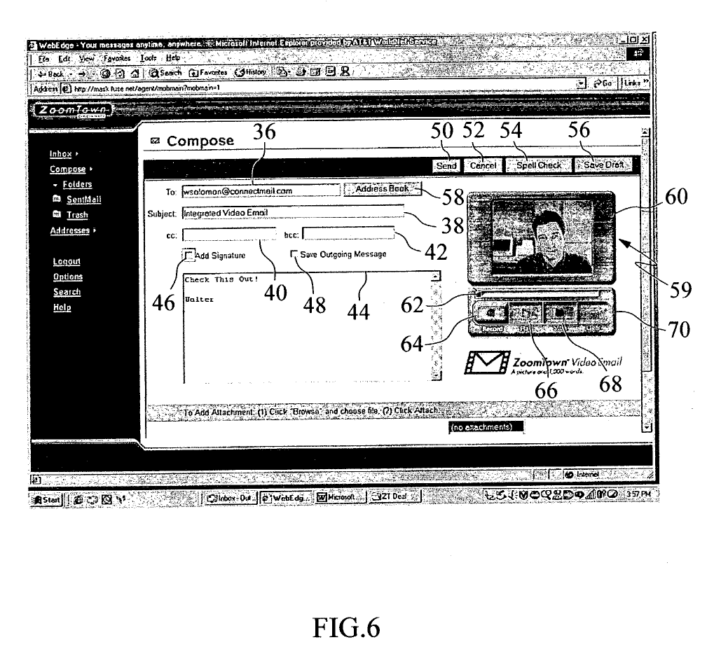

Referring now to FIG. 2, the video e-mail creation process starts at step 30 where the sender installs the camera control software on the sender's computer 10. Advancing to step 32, the sender will access the e-mail server 14 over the Internet. Advancing to step 34, the sender's computer downloads the compose screen code (HTML and JAVA Script, in the exemplary embodiment) from the e-mail server 14 to the sender's Internet browser application. This compose screen code may appear on the sender's Internet browser as shown, for example, in FIG. 6.

Referring to FIG. 6, the compose screen will include conventional e-mail composition elements such as a “To:” field 36, a “Subject:” field 38, a “CC:” field 40, a “BCC:” field 42, a “Text Composition” field or window 44, an “Add Signature” field 45, a “Save Outgoing Message” field 48, a “Send” button 50, a “Cancel” button 52, a “Spell Check” button 54, and a “Save Draft” button 56. An address book button 58 is also positioned approximate the “To” field to allow the sender to access his or her stored addresses to be inserted into the “To”, “CC:” or “BBC:” fields. The compose screen will also include a “Browse” button (not shown) that, once clicked by the “user”, will allow the user to browse the sender's computer memory devices (hard drives, CD drives and the like) to select a file in which to attach to the e-mail message.

As mentioned above, the compose screen code will also include JAVA Script downloaded from the e-mail server 14 that: (1) provides a graphical user interface to the camera control functions and (2) acts as an interface between the camera control software, the e-mail composition elements and the video server. As shown in FIG. 6, this JAVA Script will create a graphical interface 59 within the compose screen similar to a TV/VCR interface that includes a display window 60 within the compose screen for displaying video images representing what the video camera 20 is presently viewing, or for displaying a video images of a previously recorded video. The interface 59 may include a progress bar 62 that provides a graphical indication of a progress of a recording during recording or the progress of through a video during playback. Also included in the interface are a Record button 64, a Play button 66, a Stop button 68 and a Clear button 70. When the sender activates the Record button 64 interface code will cause the camera control software to begin recording video images captured by the video camera 20 that are stored in memory of the sender's computer 10. This video capture may only last for a predetermined period of time and the progress into that predetermined period of time may be indicated by the progress bar 62. The Stop button 68 allows the sender to stop recording of the video prior to the predetermined time limit and the Clear button 70 allows the sender to clear/erase the video from memory in the case where, for example, the sender wishes to record a different video. Once a video has been recorded and stored, the Play button 66 allows the user to replay the recorded video and the progress bar 62 may indicate the progress through that prerecorded video. During the replay of the video, the Stop button 68 allows the user to stop the replay at any time.

Referring back to FIG. 2, as discussed above, the sender will use the compose screen in step 72 to compose the text e-mail in the Text Composition field 44, attach any desired attachments and record a video on the senders computer using the graphical interface 59. The exemplary embodiment of the present invention will also allow the camera control software to record an audio-only recording if, for example, the sender's computer does not have a video camera operatively coupled thereto or if the video camera is presently being used for another application. For the purpose of this application, therefore, it will be understood that the “media” being compressed, stored, transferred and streamed according to the embodiments disclosed herein may be limited to recorded audio data, may be recorded audio and video data, and may be limited to recorded video data.

Advancing to step 74, the sender, when satisfied with the e-mail message and recorded video, will activate the “Send” button 50. Advancing to Step 76, upon activation of the “Send” button 50, the camera control software will compress the recorded media, upload the compressed media to the video server 16, and retrieve a video ID from the video server for this uploaded media. Advancing to step 78, the compose screen code will grab the video ID retrieved from the video server 16 and insert the video ID along with a URL or link to the video server into the code and/or text of the e-mail message that will be sent by the sender's computer 10 to the e-mail server 14.

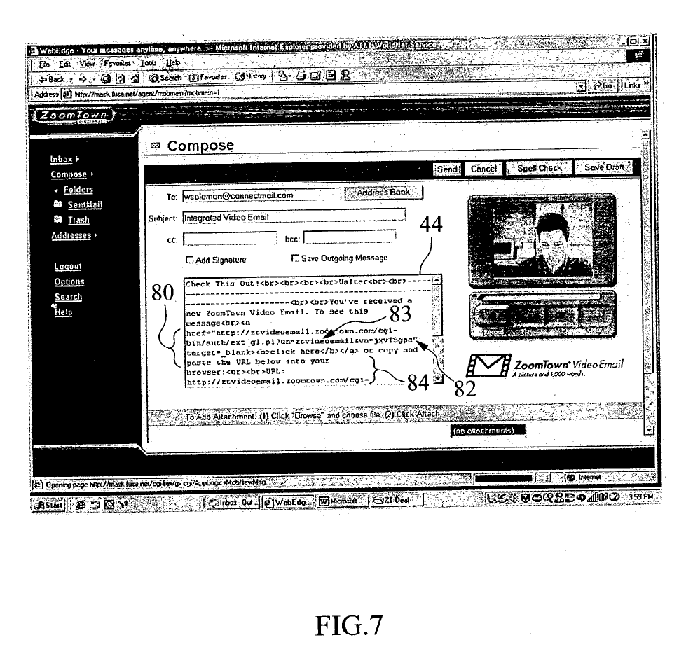

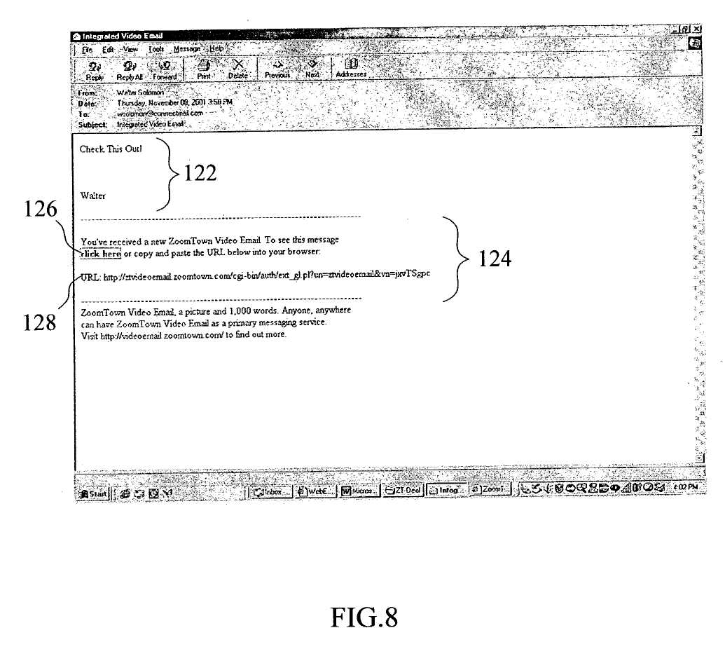

Referring to FIG. 7, the Text Composition window 44 in the exemplary embodiment displays HTML coded content of the e-mail message that is being sent to the e-mail server 14. This code includes the code 80 that provides a hypertext link in the recipient's email message (see numeral 126 in FIG. 8) to the location of the media on the video server 16, where the URL defined in this code 80 includes the video ID 82 (in this case “jxvTSgpc”) and also includes the sender's ID (in this case “ztvideoemail”). The use of the sender's ID will be discussed in greater detail below. This code will also include code 84 (all the code is note shown) for establishing a text display in the recipient's email message which displays the same Web address of the link (see numeral 128 in FIG. 8) in which, if the link 126 does not work or is not properly established by the recipient's e-mail software or Internet browser, the recipient can copy into the address (“go to”) field of the recipient's browser.

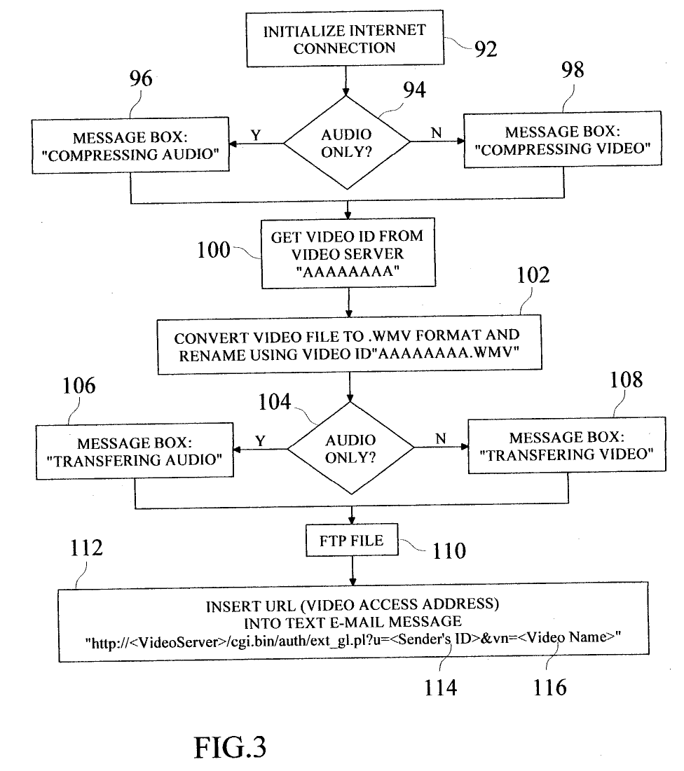

FIG. 3 provides a detailed flow summary of the process, discussed above, for the camera control software process of getting a video ID and uploading the saved media to the video server 16. Starting at step 92, the camera control software will first initialize an Internet connection. If, in step 94, the camera control software determines that the media is audio only media, the process will advance to step 96 where the compose screen will display a “compressing audio” message, and if the media includes audio and video, or only video, the process will advance to step 98 in which the message box will display “compressing video” on the compose screen. Advancing to step 100, the camera control software will then request a video ID for the stored media from the video server 16. To request this video ID, the camera control software will send, in the exemplary embodiment, the following HTTP request to the video server 16:

http://[videoserver]/cgi-bin/auth/ext_getid.pl?USER_ID=ztvideoemail

This request designates the video server 16 to execute a Pearl software function entitled “getid.pl” and passes along the sender's User ID “ztvideoemail” as an operand for this software function, identifying the sender and/or the sender's computer. The video server 16 will then verify the User ID, matching the User ID with a subscribed user; and, if verified, will return a video ID to the camera control software in the form of an XML reply in the exemplary embodiment, as shown below:

<EXTERNAL_CLIENT>

<CONFIRM>TRUE</CONFIRM>

<VIDEO_ONLY_URL>http://[videoserver]/auth/users/jxvTSgpc.wmv</VIDEO_ONLY_URL>

<VIDEO_ID>48ei6lsc95wylfiqnm3256tkvopvie.5239vvje31a90dcjlsle33vafkeddrt333fvi7678ldvivi ficdlvkie.eivdididimsivieggorllse23lfivegh0v.vg9vben9323c

</VIDEO_ID>

<USER_ID>ztvideoemail</USER_ID>

<FTP_LOC>/export/home/conmail/htdocs/auth/users/</FTP_LOC>

<VIDEO_URL>http://[videoserver]/cgi-bin/auth/ext_gl.pl?un=ztvideoemall&vn=jxvTSgpc

<VIDEO-URL>

<VIDEO_NUM>jxvTSgpc</VIDEO_NUM>

</EXTERNAL_CLIENT>

Where, <CONFIRM>TRUE indicates that the user is valid; <VIDEO_ONLY_URL> is the address that is used by the Windows Media Player to access the media stream on the recipient's computer; <VIDEO_ID> is the encoded FTP address, user ID and password; <FTP_LOC> is the directory to which the media file should be sent via FTP; <VIDEO_URL> is the link that a recipient clicks (if the link is enabled) to see the HTML web-based viewer; and <VIDEO_NUM> is the name the media file should receive when sent via FTP to the server.

Advancing to step 102, the camera control software will then convert the media file to a “.wmv” format and rename the media file to the video ID with the .wmv extension. If, in step 104, the camera control software determines that the stored media is audio only, the process will advance to step 106 where the compose screen will display a “transferring audio” message, and if a stored media includes audio and video, or only video, the process will advance to step 108 in which the message box will display “transferring video” on the compose screen. Advancing to step 110, the camera control software will use FTP to transfer the compressed .wmv media file from the user's computer 10 (hard drive) to the video server 16 using the information gathered in the XML reply from the video server, discussed above. The camera control software will then request the video server 16 to create the .asx file using the following HTTP request:

http://[videoserver]/cgi-bin/auth/ext_getuser.pl?USER_ID=ztvideoemail& VIDEO_ID=jxvTSgpc

Finally, advancing to step 112, as discussed above, the compose screen code will create a code for a hypertext link and insert it within the e-mail message code which, when activated by the recipient, will call the video server 16 to stream media as identified by the sender's ID 114 and the video name 116.

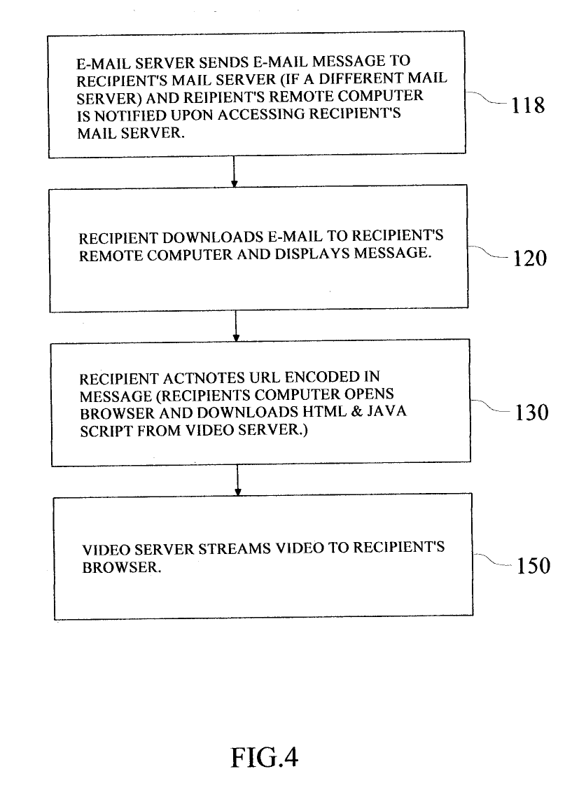

As shown in FIG. 4, a process for receiving the e-mail and displaying the media message by the recipient begins with step 118 in which the e-mail server 14 sends the e-mail message to the recipient's mail server 15 (if the recipient uses a different mail server) and the recipient's remote computer is notified of this e-mail (in a conventional manner) upon accessing the recipient's mail server. Advancing to step 120, the recipient downloads the e-mail to the recipient's remote computer 12 and displays the e-mail message using the recipient's browser or e-mail software. An example of such an e-mail message is shown in FIG. 8. As shown in FIG. 8, this e-mail message includes the text 122 created in the Text Composition window 44 of the sender's compose screen and also includes text and links 124 automatically inserted into the email by the compose screen code. This inserted text and links may include a link 126 to the video server, where the links includes the sender's ID number along with the video name and also includes an address 128 that can be cut and pasted into the recipient's web browser address field if the link 126 doesn't work.

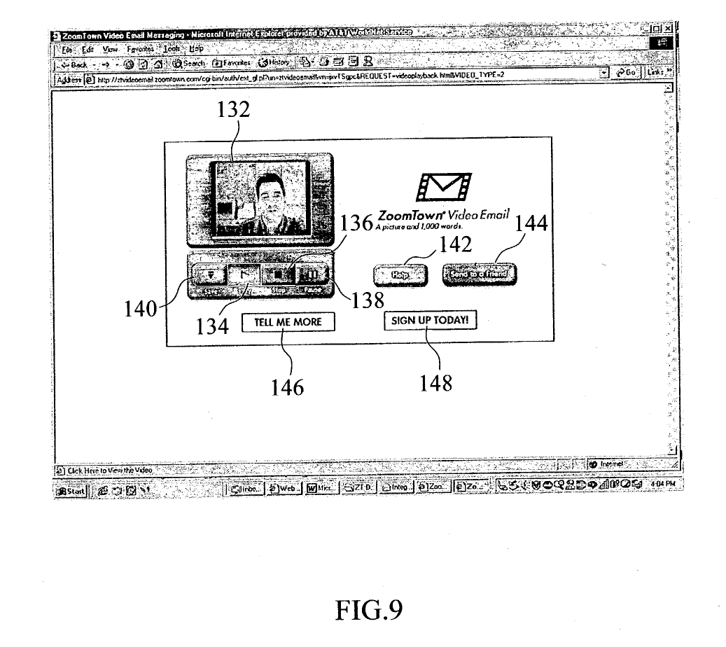

Advancing to step 130, when the recipient activates the link 126 embedded in the message, the recipient's computer opens a browser and downloads HTML and JAVA Script from the video server (assuming that the video server recognizes these sender's id and video name indicated by the link). An example of such a video viewing screen downloaded by the video server is shown in FIG. 9. This page will include a window 132 for displaying the recorded video, a Play button 134, a Stop button 136, a Pause button 138 and a Save button 140. The web page will also include a Help button 142, if the user wishes to learn more about the viewing process or if the recipient is having problems with viewing the media. The above components of the video viewing screen may be provided by, or interact with, Windows Media Player (or similar software) operating on the recipient's computer. When the recipient activates the Play button, the process will advance to step 150 and the Windows Media Player code on the recipient's computer will begin streaming the media from the Video Server 16 or from the Windows Media Server 18. As will be apparent to those of ordinary skill, the Stop, Pause and Save buttons call to expected functions of the Windows Media Player code. The recipient's web page may also include a “Send to a Friend” button 144 which allows the recipient to send the media message to a friend; a link 146 that will open a web page providing more information about the video e-mail message the process; as well as a link 148 to a web page in which the recipient can sign up for the video message service.

Following from the above detailed description, it will be apparent to those of ordinary skill in the art that, while the apparatuses and processes herein described constitute exemplary embodiments of the present invention, it is understood that the invention is not limited to these precise apparatuses and processes and that changes may be made therein without departing from the scope of the invention as claimed or as illustrated by the various aspects of the present invention set forth in the summary. Additionally, it is to be understood that the invention is defined by the claims and it is not intended that any limitations or elements describing the exemplary embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A computer network-based video email system comprising:
(a) a sender's remote computer operatively coupled to a global computer network, the sender's remote computer including a display screen, at least one manual i/o device, a video camera, at least one of (i) a browser application and (ii) a dedicated electronic messaging application installed thereon, and a camera control application installed thereon;
(b) a recipient's remote computer operatively coupled to the global computer network, the recipient's remote computer including a display screen, at least one manual i/o device, and at least one of (i) a browser application and (ii) a dedicated electronic application installed thereon;
(c) an electronic message server operatively coupled to the global computer network, including composing screen code downloadable by the sender's remote computer and compatible with the browser or dedicated electronic messaging application installed on the sender's remote computer, the composing screen code being configured to provide,
(i) electronic-message composition graphical interface elements, enabling the sender to compose an electronic message using the browser or dedicated electronic messaging application,
(ii) video recording graphical interface elements enabling the sender to direct and monitor the recording of media on the sender's computer, and
(iii) functional interface elements providing a functional interface between at least the video recording graphical interface elements and the camera control application installed on the sender's remote computer; and
(d) a video server operatively coupled to the global computer network adapted to stream media to the recipient's remote computer;
(e) wherein the camera control software is configured to (i) record media onto the sender's remote computer, (ii) communicate with the video server to upload the recorded media to the video server, (iii) to obtain or define an identity of the uploaded media, and (iv) to interface with the functional interface elements of the composing screen code for inserting an address to the video server along with the identity of the uploaded media into the composed electronic message.

2. The computer network-based video email system of claim 1, wherein the video server is adapted to stream media to the recipient's remote computer through another server.

3. The computer network-based video email system of claim 1, wherein the address to the video server inserted into the composed electronic message includes a hyper-link.

4. A computer implemented video messaging method, comprising the steps of:
(a) accessing a sender's electronic message server computer over a computer network by a sender's computer;
(b) downloading, by the sender's computer, compose screen code from the sender's electronic message server to an electronic messaging application running on the sender's computer;
(c) composing a message using the compose screen and recording a video on the sender's computer utilizing camera control software installed on the user's computer that interacts with the compose screen code;
(d) activating an icon on the compose screen associated with a send-message command;
(e) the camera control software on the sender's computer performing the steps of, in no specific order, compressing the recorded video, uploading the compressed video to a video server over the computer network, and retrieving a video identification from the video server;
(f) inserting, by the compose screen code on the sender's computer, the video identification, along with an address to the video server, into the composed message;
(g) uploading, by the sender's computer, the composed message with the inserted video identification and address to the sender's electronic message server;
(h) sending, by the sender's electronic message server, the composed message with the inserted video identification and address to a recipient's electronic message server;
(i) accessing the recipient's electronic message server computer over a computer network by a recipient's computer;
(j) downloading, by a recipient's computer, the composed message with the inserted video identification and address to a browser or an electronic messaging application running on the recipient's remote computer, which displays the message;
(k) accessing, by the recipient's computer, the video from the video server over the computer network using the video identification and address inserted in the composed message;
(l) downloading, by the electronic messaging application running on the recipient's remote computer, code from the video server to set up a video viewing window on the recipient's remote computer; and
(m) streaming, by the video server to the video viewing window on the recipient's computer, over the computer network, the accessed video.

5. The computer implemented method of claim 4, wherein the sender's electronic message server and the recipient's electronic message server are a single server.

6. The computer implemented method of claim 4, wherein the sender's electronic message server and the recipient's electronic message server are separate servers.

7. The computer implemented method of claim 4, wherein the steps (a) through (m) are not necessarily sequential.

8. The computer implemented method of claim 4, wherein the step (a) through (m) are sequential.
